(19) United States
(12) Patent Application Publication
(10) Pub. No.: US 2026/0210737 A1
(43) Pub. Date: Jul. 23, 2026

(54) Capacitance Sensing Method for Emergency Stop Moving Part, Processor of Capacitance Sensing of Approaching or Touching Object for Emergency Stop Moving Part, and System Thereof

(71) Applicant: EGALAX_EMPIA TECHNOLOGY INC., Taipei City (TW)

(72) Inventor: Shang-Tai Yeh, Taipei City (TW)

(21) Appl. No.: 19/454,456

(22) Filed: Jan. 21, 2026

Related U.S. Application Data
(60) Provisional application No. 63/747,789, filed on Jan. 21, 2025.

(51) Int. Cl. G01D 5/24; F04D 27/00; H02P 1/16; H02P 3/06

(52) U.S. Cl. CPC G01D 5/24; F04D 27/008; H02P 1/16; H02P 3/06

(57) ABSTRACT

A capacitance sensing method for emergency stop moving part applicable to a processor of capacitance sensing of approaching or touching object is provided. The capacitance sensing method for emergency stop moving part comprises providing driving signals to a driving electrode and sensing the driving signals induced by a sensing electrode in order to detect an external conductive object approaching or touching a protection shield for the moving part, wherein a first capacitor is formed by the protection shield and the driving electrode, a second capacitor is formed by the protection shield and the sensing electrode; determining a strength of the sensed driving signals; and when the strength of the sensed driving signals exceeds a threshold, notifying a controller of the moving part to stop the moving part.

### CROSS REFERENCE TO RELATED PATENT APPLICATION

This patent application is based on a provisional patent application No. 63/747,789 filed on January 21, 2025.

### FIELD OF THE INVENTION

The present invention relates to emergency stop, especially related to processor and method for capacitance sensing of approaching or touching.

### BACKGROUND OF THE INVENTION

In modern life, there are many electric driven apparatuses, such as electric fan and chainsaw etc. They contain high-speed moving parts which may do harm to human being. Thus, they usually include protecting shields.

Please refer to FIG. 1, which is a diagram of existing electric fans 100. The electric fans 100 comprises a standing base 110, a control panel 120, a protection case of motor 130, rotating fans 140, and a protection shield 150 covering the rotating fans 140. There are many buttons or control elements on the control panel 120 for stop or start the rotating fans 140 in different rotational speeds. Damages occur when the rotating fans touch human body or other objects. As a result, the protection shield 150 covers the fans 140 entirely.

However, the main purpose of the rotating fans 140 is to blow air to the front. Hence, the protection shield 150 must comprise gaps. Otherwise, the air cannot be blown out. The larger the gaps, the better the blowing effects. But the protection effect becomes weaker. Instead, if the gaps of the protection shield 150 are getting closer for better protection effects, the blowing effects become worse. These two effects are contradictory.

Consequently, there exists a need of a mechanism for enhancing protection effects while maintaining effects of moving objects.

### SUMMARY OF THE INVENTION

According to an embodiment of the present application, a capacitance sensing method for emergency stop moving part applicable to a processor of capacitance sensing of approaching or touching object is provided. The capacitance sensing method for emergency stop moving part comprises providing driving signals to a driving electrode and sensing the driving signals induced by a sensing electrode in order to detect an external conductive object approaching or touching a protection shield for the moving part, wherein a first capacitor is formed by the protection shield and the driving electrode, a second capacitor is formed by the protection shield and the sensing electrode; determining a strength of the sensed driving signals; and when the strength of the sensed driving signals exceeds a threshold, notifying a controller of the moving part to stop the moving part.

Preferably, in order to let the user conveniently sets the sensitivity, the method further comprises receiving setting information from a control element; and adjusting the threshold's value according to the setting information.

Preferably, in order to prevent the sensing of the driving signals from electromagnetic interference generated by the moving part at high speed, the method further comprises receiving speed setting information from the controller; and adjusting modulation and demodulation of the driving signals based on the speed setting information.

Preferably, in order to prevent the sensing of the driving signals from electromagnetic interference generated by the moving part at high speed, wherein the modulation and the demodulation of the driving signals are based on frequency.

Preferably, in order to prevent the sensing of the driving signals from electromagnetic interference generated by the moving part at high speed, wherein modulation and demodulation of the driving signals are based on pseudo-random numbers.

Preferably, in order to prompt the user who is in danger, the method further comprises: when strength of the sensed driving signals exceeds the threshold, notifying at least one output device to send a first signal to the user.

Preferably, in order to prompt the user who is in safe, the method further comprises: when the strength of the sensed driving signals is less than the threshold, notifying the at least one output device to send a second signal to the user.

Preferably, in order to save power, the method further comprises: after receiving an instruction indicating that the moving part has started moving, performing the above mentioned steps.

Preferably, in order to provide automatic restart function, the method further comprises: after the controller is notified to stop the moving part, performing repetitively the above mentioned steps until the strength of the sensed driving signal is less than the threshold, notifying the controller to start moving the moving part.

Preferably, in order to conveniently unload the protection shield for cleaning by the user, wherein the driving electrode and the sensing electrode are installed inside or on a surface of a protection shield of a motor of the moving part so as the driving electrode and the sensing electrode do not directly contact conductive material of the protection shield for the moving part.

Preferably, in order to prevent electromagnetic interference caused by the rotations of the motor, wherein there is a shielding layer between a motor of the moving part and the driving and the sensing electrodes, the shielding layer is coupled to ground voltage or a direct current voltage.

According to an embodiment of the present application, a processor of capacitance sensing of approaching or touching object for emergency stop moving part is provided. The processor, comprising: a driving circuit module for providing driving signals to a driving electrode; a sensing circuit module for sensing the driving signals induced by a sensing electrode in order to detect an external conductive object approaching or touching a protection shield for the moving part, wherein a first capacitor is formed by the protection shield and the driving electrode, a second capacitor is formed by the protection shield and the sensing electrode; an interface module for connecting with a controller of the moving part; and a processing circuit for determining a strength of the sensed driving signals; and when the strength of the sensed driving signals exceeds a threshold, notifying a controller of the moving part to stop the moving part via the interface module.

Preferably, in order to let the user conveniently sets the sensitivity, wherein the interface module is further configured for receiving setting information from a control element; and the processing circuit is further configured for adjusting the threshold's value according to the setting information.

Preferably, in order to prevent the sensing of the driving signals from electromagnetic interference generated by the moving part at high speed, wherein the interface module is further configured for receiving speed setting information from the controller; and wherein the processing circuit is further configured for adjusting modulation and demodulation of the driving signals based on the speed setting information.

Preferably, in order to prevent the sensing of the driving signals from electromagnetic interference generated by the moving part at high speed, wherein the modulation and the demodulation of the driving signals are based on frequency.

Preferably, in order to prevent the sensing of the driving signals from electromagnetic interference generated by the moving part at high speed, wherein modulation and demodulation of the driving signals are based on pseudo-random numbers.

Preferably, in order to prompt the user who is in danger, wherein the processing circuit is further configured for when strength of the sensed driving signals exceeds the threshold, notifying, via the interface module, at least one output device to send a first signal to the user.

Preferably, in order to prompt the user who is in safe, wherein the processing circuit is further configured for when the strength of the sensed driving signals is less than the threshold, notifying, via the interface module, the at least one output device to send a second signal to the user.

Preferably, in order to save power, wherein after receiving an instruction indicating that the moving part has started moving, the processor is configured for performing the above-mentioned steps.

Preferably, in order to provide automatic restart function, wherein after the controller is notified to stop the moving part, the processor is configured for performing repetitively the above-mentioned steps until the strength of the sensed driving signal is less than the threshold, notifying, via the interface module, the controller to start moving the moving part.

Preferably, in order to conveniently unload the protection shield for cleaning by the user, wherein the driving electrode and the sensing electrode are installed inside or on a surface of a protection shield of a motor of the moving part so as the driving electrode and the sensing electrode do not directly contact conductive material of the protection shield for the moving part.

Preferably, in order to prevent electromagnetic interference caused by the rotations of the motor, wherein there is a shielding layer between a motor of the moving part and the driving and the sensing electrodes, the shielding layer is coupled to ground voltage or a direct current voltage.

According to an embodiment of the present application, a system for emergency stop moving part is provided. The system comprises the abovementioned moving part, the protection shield for the moving part, the driving electrode, the sensing electrode, and the processor of capacitance sensing of approaching and touching object.

Person having ordinary skill in the art can understand that one of the inventive characteristics of the present application is to add conductive material into the protection shield for the moving parts such that two capacitors can be formed between the protection shield and the driving electrode and the sensing electrode, respectively. When an external conductive object is detected by the processor of capacitance sensing of approaching or touching the protection shield via the driving electrode, the protection shield, and the sensing electrode, the controller of the moving parts would be notified to stop the operations of the moving parts.

Another one of the inventive characteristics of the present application is that the electromagnetic interference signal generated by the high-speed moving parts is put into considerations. And anti-jammer method is facilitated to prevent false stop.

Another one of the inventive characteristics of the present application is that various sensitivities are required in different environments. Therefore, a configurable threshold is provided to adopt to different environments.

Person having ordinary skill in the art can understand that the moving parts as recited in the present application are not limited to the electric fans. Other kinds of dangerous devices such as chainsaws, washing machines, cloth dryers, and dish washers may be applicable to the present application.

### BRIEF DESCRIPTION OF THE DRAWINGS

The advantages and spirit related to the present invention can be further understood via the following detailed description and drawings.

FIG. 1 is a diagram of existing electric fans 100.

FIG. 2 depicts a block diagram of an electric fan 200 in accordance with an embodiment of the present application.

FIG. 3A depicts a block diagram of an electric fan 200 in accordance with an embodiment of the present application.

FIG. 3B shows depicts a block diagram showing human body touches the protection shield 250 as shown in FIG. 3A.

FIG. 3C illustrates a block diagram showing human body approaches the protection shield 250 as shown in FIG. 3A.

FIG. 4 depicts a block diagram of the processor 210 of capacitance sensing of approaching or touching object in accordance with an embodiment of the present application.

FIG. 5 shows a flowchart diagram of a capacitance sensing method 500 for emergency stop moving part in accordance with an embodiment of the present application.

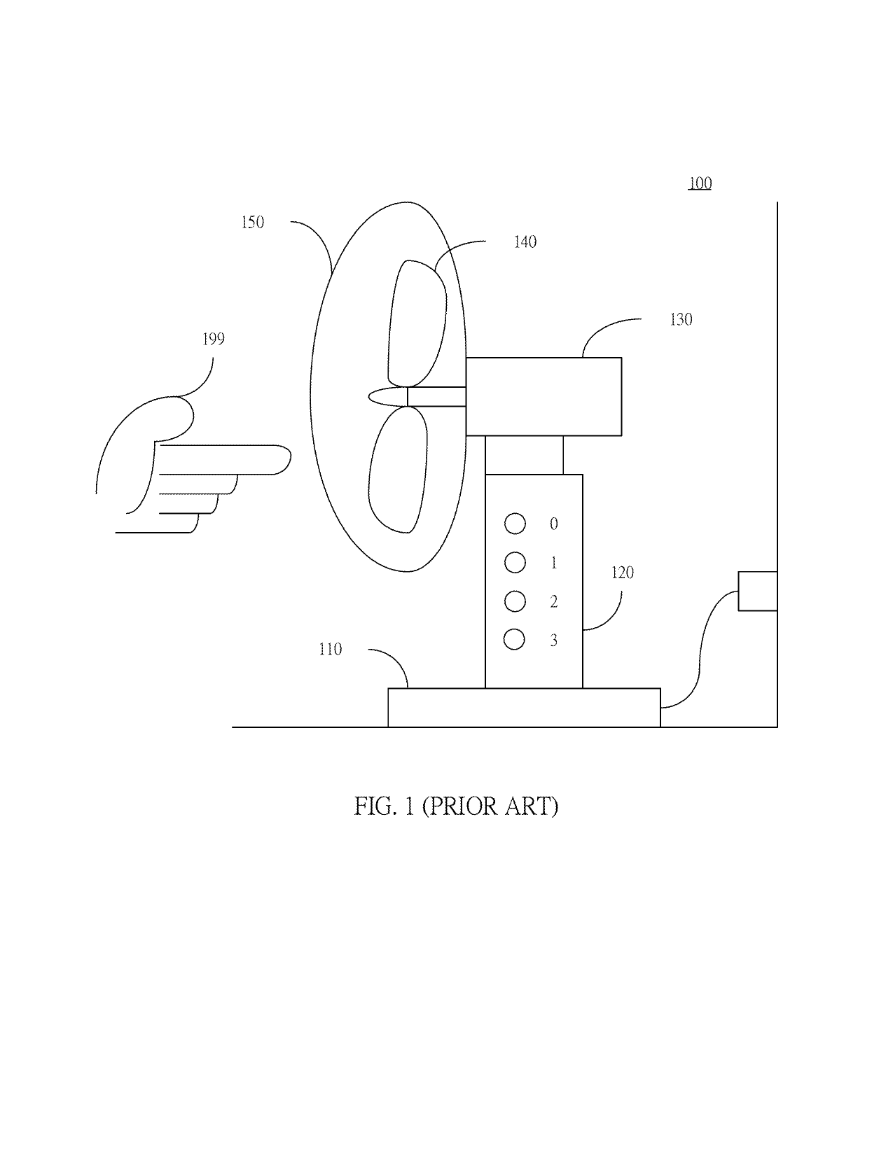

### DETAILED DESCRIPTION OF THE PREFERRED EMBODIMENT

Some embodiments of the present application are described in details below. However, in addition to the description given below, the present invention can be applicable to other embodiments, and the scope of the present invention is not limited by such rather by the scope of the claims. Moreover, for better understanding and clarity of the description, some components in the drawings may not necessary be drawn to scale, in which some may be exaggerated related to others, and irrelevant. If no relation of two steps is described, their execution order is not bound by the sequence as shown in the flowchart diagram.

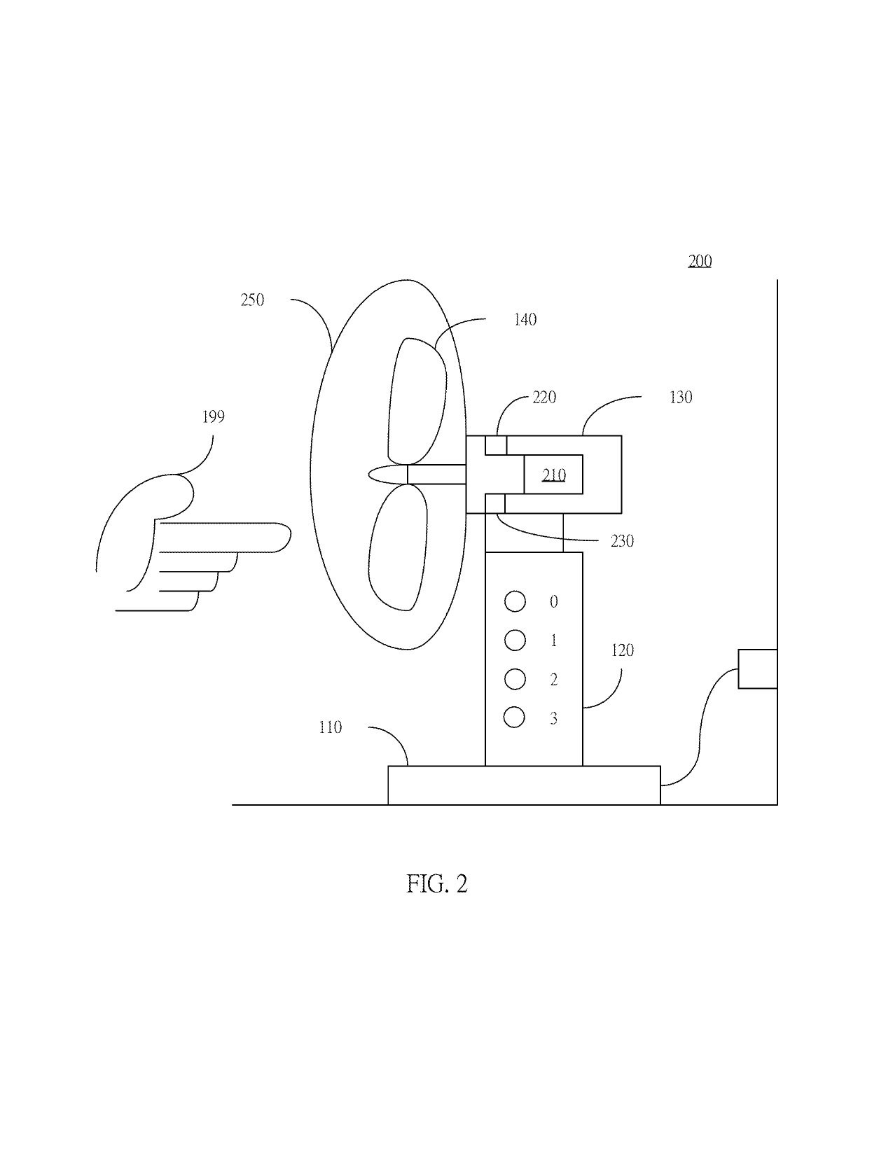

Please refer to FIG. 2, which depicts a block diagram of an electric fan 200 in accordance with an embodiment of the present application. If no special description, the electric fan 200 may inherit the description of the existing electric fan 100. The electric fan 200 comprises a sensor of capacitance sensing for detecting external conductive object, e.g., human body, approaching or touching a protection shield 250. The sensor of capacitance sensing is configured for connecting a driving electrode 220 nearby the protection shield 250, a sensing electrode 230 nearby the protection shield 250, and a processor 210 of capacitance sensing of approaching or touching object. As shown in FIG. 2, the driving electrode 220 is not electrically coupled to the sensing electrode 230. They can be disposed inside the protection case for motor 130 or on the surface of the protection case for motor 130.

The protection shield 250 may comprises conductive materials such as copper filament, iron filament, graphite, and alumina etc. The conductive materials may be used to form the protection shield 250 with non- conductive materials. The driving electrode 220 would form a first capacitor with the protection shield 250. The sensing electrode would form a second capacitor with the protection shield 250.

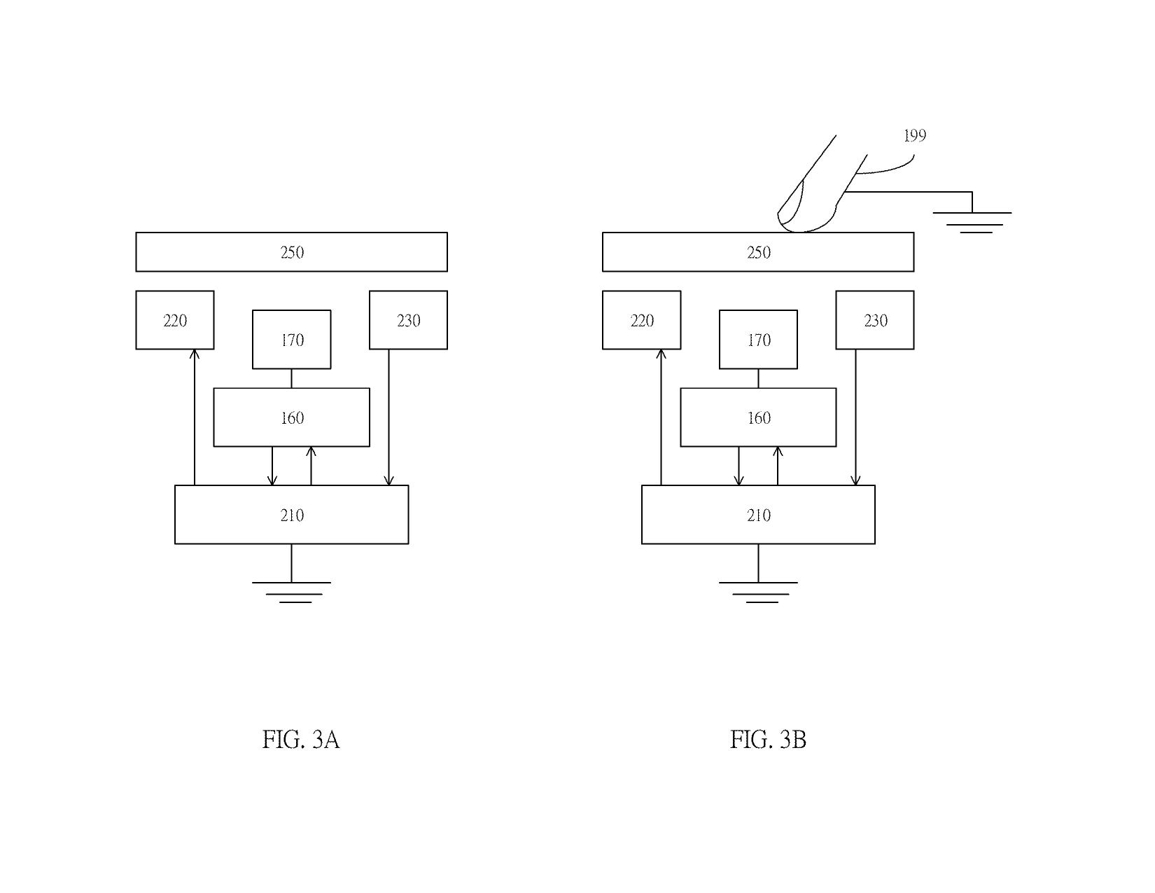

Please refer to FIG. 3A, which depicts a block diagram of an electric fan 200 in accordance with an embodiment of the present application. Please refer to FIG. 3B, which shows depicts a block diagram showing human body touches the protection shield 250 as shown in FIG. 3A. Please refer to FIG. 3, which illustrates a block diagram showing human body approaches the protection shield 250 as shown in FIG. 3A. As shown in FIG. 3A through FIG. 3C, the electric fan 200 further comprises a fan control circuitry 160 and a motor 170. The control elements of the touch panel 120 may be connected to the fan control circuitry 160 for starting the motor 170 with indicated rotational speed or stopping the motor 170.

In one embodiment, when the fan control circuitry 160 receives instruction for starting the motor 170, the processor 210 of capacitance sensing of approaching or touching object would be notified to start the approaching and touching sensing via the protection shield 250. In one embodiment, the fan control circuitry 160 may also transmit the rotational speed related information of the motor 170 to the processor 210 of capacitance sensing of approaching or touching object. Similarly, when the fan control circuitry 160 receives instruction for stopping the motor 170, the processor 210 of capacitance sensing of approaching or touching object would be notified for stopping the approaching or touching detection of the protection shield 250.

The processor 210 of capacitance sensing of approaching or touching object would transmit driving signals to the driving electrode 220. The driving signals would be induced by the sensing electrode 230 via the first capacitor and the second capacitor. The processor 210 of capacitance sensing of approaching or touching object is able to detect the induced driving signals of the sensing electrode 230. When variations occur to the driving signal as shown in FIG. 3B and FIG. 3C, it means that some of the driving signals propagate to external ground potential via the external conductive object (e.g., human body 199) approaching or touching the protection shield 250. Thus, the signal strength of the driving signals induced by the sensing electrode 230 shrinks. The processor 210 of capacitance sensing of approaching or touching object is able to detect whether the variation of signal strength exceeds a threshold. When the variation exceeds the threshold, the processor 210 of capacitance sensing of approaching or touching object may notify the fan control circuitry 160 for stopping the motor 170.

In one embodiment, the driving signals may be modulated to a specified frequency. The processor 210 of capacitance sensing of approaching or touching object may detect the signal strength of the driving signals induced by the sensing electrode 230 at the specified frequency. The specified frequency may not be interfered with the frequencies generated by the motor. Hence, when the processor 210 of capacitance sensing of approaching or touching object receives the rotational speed related information from the fan control circuitry 160, the specified frequency may be changed after a certain time period in order to prevent interference from a new frequency generated by the motor operating in the new rotation speed.

In an alternative embodiment, the driving signals may be encoded signals modulated with respect to pseudo random numbers in order to prevent electromagnetic interference signals caused by high-speed rotations of the motor, or even other interference signals brought by the external conductive object, e.g., human body. The processor 210 of capacitance sensing of approaching or touching object can demodulate the encoded signals modulated in pre-determined methods to determine whether the signal strength variation exceeds the threshold. Applicant already filed several patent applications to provide how to modulate and demonstrate signals encoded with pseudo random ii numbers. Person having ordinary skill in the art may apply the disclosed content of those patent applications to the present application. In the embodiment, it may not need to change the encode method of the driving signals when the motor changes its rotational speed because the anti-jamming capability of the encoded signals modulated with pseudo random numbers is better.

In one embodiment, the control panel 120 may further comprise a control element 450 for setting the threshold. For examples, the control element 450 may be a knob or a slider for setting the threshold. In other words, it is used to set the sensitivity of the approaching or touching detection of the protection shield 250. The higher the threshold, the lower the sensitivity. Instead, the lower the threshold, the higher the sensitivity. When children or pets may present in the environment, the user may lower the threshold. If no children or pets, the threshold may be set higher.

The control element may directly connect to the processor 210 of capacitance sensing of approaching or touching object or the fan control circuitry 160. When the fan control circuitry 160 receives a command to start the motor 170 or to adjust the setting of the control element, the fan control circuitry 160 may transmit the corresponding setting information to the processor 210 of capacitance sensing of approaching or touching object. When the processor 210 of capacitance sensing of approaching or touching object directly receives the setting information from the control element or from the fan control circuitry 160, the threshold is modified accordingly.

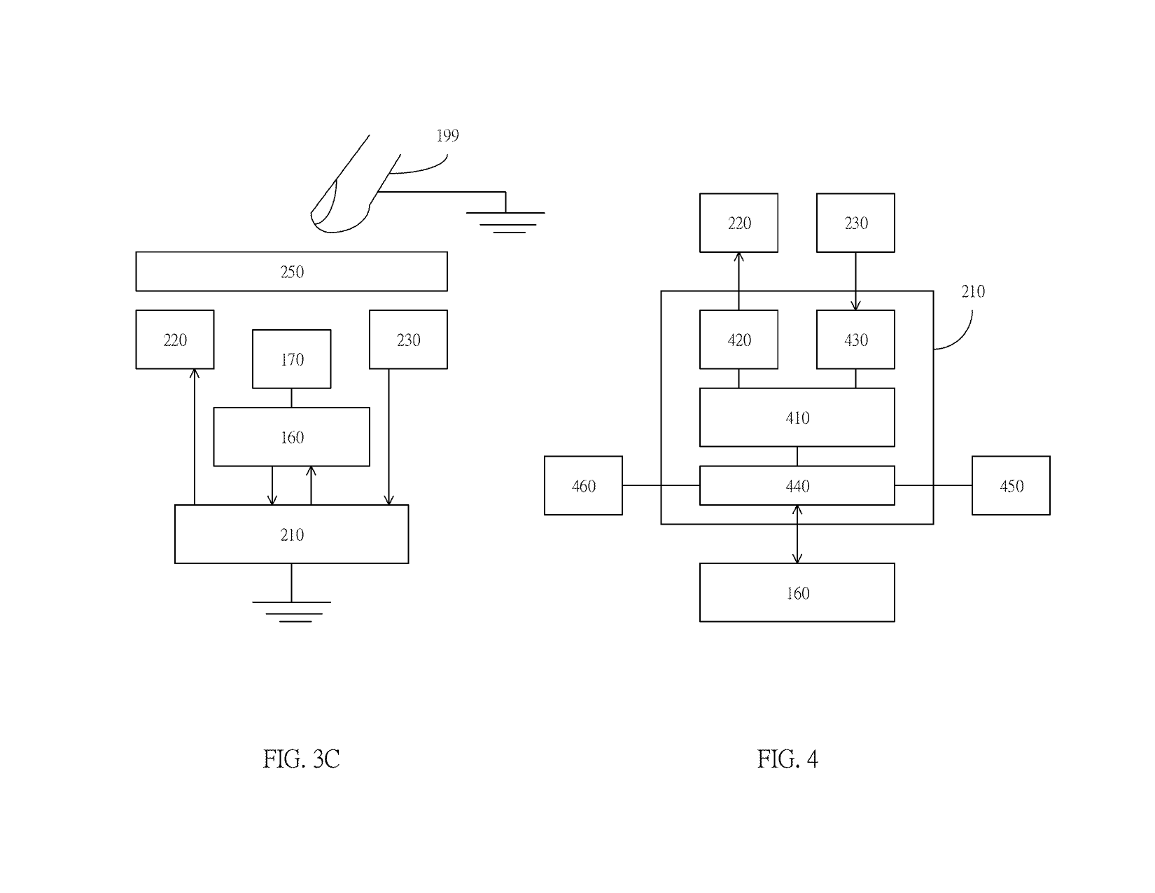

Please refer to FIG. 4, which depicts a block diagram of the processor 210 of capacitance sensing of approaching or touching object in accordance with an embodiment of the present application. The processor 210 of capacitance sensing of approaching or touching object may comprise a processing circuit 410, a driving circuit module 420, a sensing circuit module 430, and an interface module 440. The drive circuit module 420 may include components such as a clock generator, frequency divider, frequency multiplier, phase-locked loop, power amplifier, DC-DC voltage converter, rectifier, and/or filter, used to drive signals to one or more drive electrodes 220 according to the control commands of the processing circuit 410. Various analog or digital signal modulations can be applied to the drive signals to transmit certain information. The aforementioned modulation methods include, but are not limited to, frequency modulation (FM), phase modulation (Phase Modulation), amplitude modulation (AM), dual-sideband modulation (DSB), single-sideband modulation (SSB-AM), vestigial sideband modulation (VSSB-AM), amplitude-shifted modulation (ASK), phase-shifted modulation (PSK), quadrature amplitude modulation (QAM), frequency-shifted modulation (FSK), continuous phase modulation (CPM), code division multiple access (CDMA), time division multiple access (TDMA), quadrature frequency division multiplexing (OFDM), and pulse width modulation (PWM). The drive signal can contain one or more square waves, sine waves, or any modulated waveform. The drive circuit module 420 can contain one or more channels, each channel can be connected to any one or more driving electrodes 220.

The sensing circuit module 430 may include components such as an integrator, sampler, clock generator, frequency divider, frequency multiplier, phase-locked loop, power amplifier, operational amplifier, multiplier, DC-DC voltage converter, rectifier, and/or filter, used to sense one or more sensing electrodes 230 according to the control commands of the processing circuit 410. When the drive signal is emitted through the driving electrode 220, another sensing electrode 230 can sense the drive signal. The sensing circuit module 430 may be adopted to the modulation method performed by the driving circuit module 420 to demodulate the driving signal induced by the sensing electrode 230. The sensing circuit module 430 may include one or more channels, each channel can be connected to one or more sensing electrodes 230. At the same time, each channel can perform sensing and demodulation simultaneously.

In one embodiment, the driving circuit module 420 and sensing circuit module 430 may include analog front-end (AFE) circuitry. In another embodiment, in addition to the analog front-end circuitry, the driving circuit module 420 and sensing circuit module 430 may include digital back end (DBE) circuitry. When the driving circuit module 420 and sensing circuit module 430 only include analog front-end circuitry, the digital back-end circuitry may be implemented within the processing circuit 410.

The processing circuit 410 may include DSP (digital signal processor) for connecting to the AFE circuitry of the driving circuit module 420 and the sensing circuit module 430, and further connecting to the DFE circuity of the driving circuit module 420 and the sensing circuit module 430. The processing circuit 410 may include embedded processor, non-volatile memory and volatile memory. The non-volatile memory may store ordinary operating system or real-time operating system and applications operating under the operating system. The operating system and applications may include instructions and data. The processor (including embedded processor and/or DSP) executing the instructions for controlling the other modules including the driving circuit module 420, the sensing circuit module 430, and the interface module 440, of the processor 210 of capacitance sensing of approaching or touching object. For example, the processing circuit 410 may include common 8051 series, Intel i960 series, ARM Cortex-M series processors widely used in the industry. The present application does not limit the type and the number of the processors included in the processing circuit 410.

In another embodiment, the processing circuit 410 may include logic control circuit made by FPGA or ASIC. The instructions and data may be used to implement the steps provided by the present application and the flows or methods consisting of the steps. Some instructions may be independently operating within the processing circuit 410, e.g., arithmetic and logic operations. Other instructions may be used ton control other modules of the processor 210 of capacitance sensing of approaching or touching. Other modules may provide information to the operating system and/or applications executed by the processing circuit 410 via its input/output interface. Person having ordinary skill in the art should have common knowledge of computer organization and architecture to understand that the flows and methods provided by the present application can be realized by the modules and the instructions.

The interface module 440 may comprise various kinds of series or parallel communication buses, e.g., GPIO, UART, USB. I2C, PCI, PCI-Express, IEEE 1394 etc. input/output interfaces compliant with industrial standards. The processor 210 of capacitance sensing of approaching or touching may connect to the fan control circuit 160 via the interface module 440. The interface module 440 may comprise specific standard interface for connecting the fan control circuitry 160 for receiving the commands of start/stop the motor, the rotational speed related information, threshold information etc. As discussed above, the control element may connect to the interface module 440 so as that the processing circuit 410 is able to aware the threshold information corresponding to the control element.

In one embodiment, the processor 210 of capacitance sensing or approaching or touching or the interface module 440 may be used to connect to the output device 460 for prompt the user by audio and/or light visual signals. For example, when no external conductive object is detected, an external light may be commanded to present a first color (e.g., green). When an external conductive object is detected, the external light may be commanded to present a second light (e.g., red) and/or a first warning sound is emitted. When a variation of driving signals below the threshold is detected, the external light may be commanded to present a third light (e.g., yellow) and/or a second warning sound is emitted.

In an alternative embodiment, the processor 210 of capacitance sensing of approaching or touching object. may transmit information to notify the fan control circuitry 160 for emitting audio and/or light visual signals to prompt the user.

In one embodiment, in order to prevent the processor 210 of capacitance sensing of approaching or touching object failing to operate when the interface module 440 or the fan control circuitry 160 fails, the processor 210 of capacitance sensing of approaching or touching object may keep detect external conductive objects continuously. As long as the processor 210 of capacitance sensing of approaching or touching object is on with electricity supply, the detection of external conductive objects is kept on continuously. When the external conductive object is detected, the fan control circuitry 160 is notified to stop the motor 170 no matter whether the fan control circuitry 160 is operating or not. In other words, in this embodiment, the processor 210 of capacitance sensing of approaching or touching object only transmits notification to the fan control circuitry 160. It is not required to receive any information from the fan control circuitry 160.

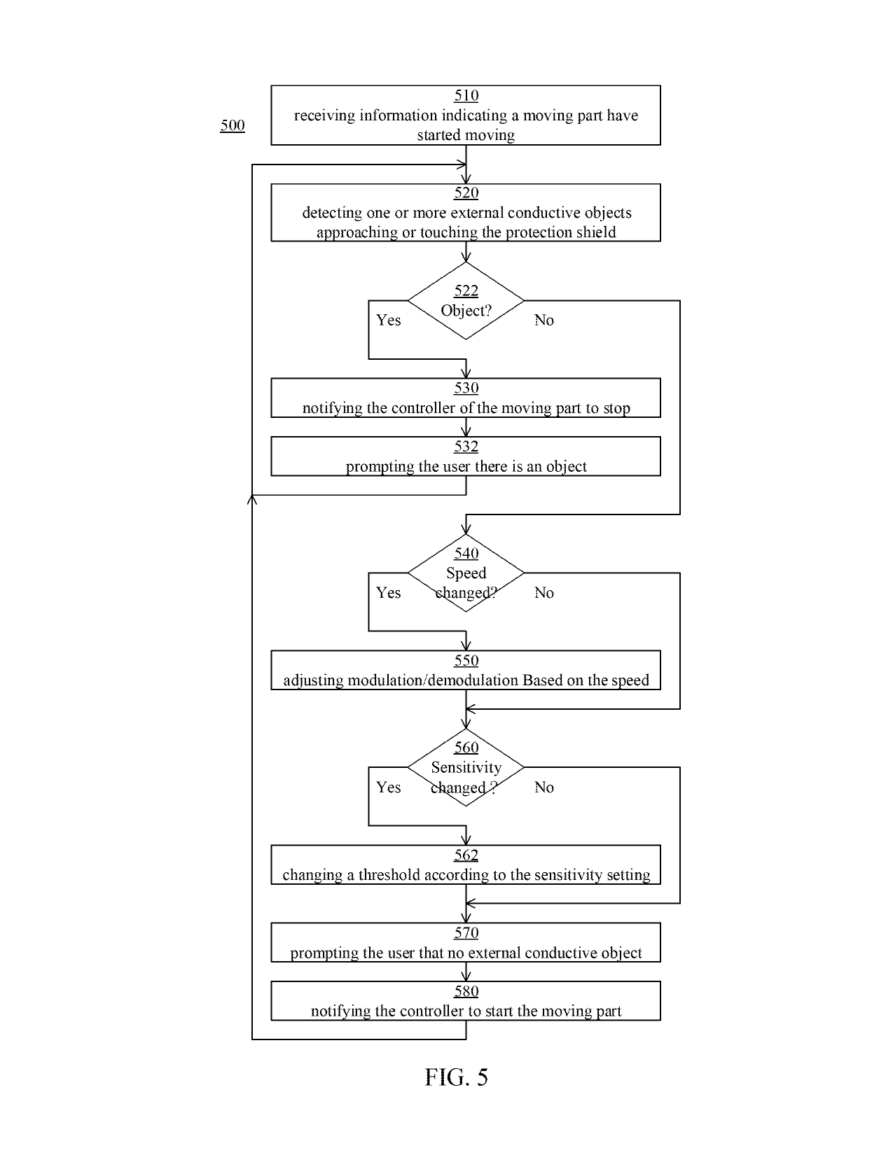

Please refer to FIG. 5, which shows a flowchart diagram of a capacitance sensing method 500 for emergency stop moving part in accordance with an embodiment of the present application. The capacitance sensing method 500 for emergency stop moving part may be appliable to the processor 210 of capacitance sensing of approaching or touching object as shown in FIG. 2. In one embodiment, it may be applicable to the processing circuit 410 as shown in FIG. 4. For example, the processor of the processing circuit 410 may execute multiple instructions stored in non-volatile memory to fulfill the capacitance sensing method 500 for emergency stop moving part. Besides, it may use FPGA or ASIC to implement the capacitance sensing method 500 for emergency stop moving part. If there is no direct or indirect causal relationship between any two steps, the present application does not limit the execution sequence of these two steps. The capacitance sensing method 500 for emergency stop moving part may begin at step 510 or step 520.

Step 510: receiving information indicating a moving part have started moving. For example, the information indicating the motor 170 has started moving came from the fan control circuit 160 may be received. In an alternative embodiment, when the processor 210 of capacitance sensing of approaching or touching object continuously detects approaching or touching objects, and it does not receive the information from the fan control circuit 160, the step is not required.

Step 520: detecting one or more external conductive objects approaching or touching the protection shield for the moving part. In the present step, the processor 210 of capacitance sensing of approaching or touching object may have the driving circuit module 420 transmitting driving signals to the driving electrode 220. Meanwhile, the processor 210 of capacitance sensing of approaching or touching object have the sensing circuit module 430 receiving the driving signals induced by the sensing electrode 230.

Step 522: after demodulating the received driving signals, the processor 210 of capacitance sensing of approaching or touching object may determine whether one or more external conductive objects approaching or touching the protection shield 520 for the moving part based on whether the sensed value of the driving signal exceeds a threshold. The protection shield 250 comprises conductive materials, which work with the driving electrode 220 to form a first capacitor. The conductive material of the protection shield 250 work with the sensing electrode 230 to form a second capacitor. When it is determined that there exists one or more external conductive objects approaching or touching the protection shield 250, the driving electrode 220, and/or the sensing electrode 230, the flow may proceed to step 530. Otherwise, the flow may proceed to step 540, step 560, or step 570.

Step 530: notifying the controller of the moving part to stop the moving part. For example, the fan control circuit 160 may be notified to emergency stop the motor 170 for driving the fans.

Step 532: prompting the user that there is one or more external conductive objects approaching or touching the protection shield. For example, the output device 460 may be directly notified to send audio signal, light or visual signal, and vibration signal to prompt user. In addition, in one embodiment, it may send warning messages to remote users via a network communication device. Next, the flow may be finished or returned to step 520.

Step 540: determining whether the moving part changes its speed setting. For example, when information indicating changes of speed setting is received from the fan control circuit 160, the flow may proceed to step 550. Otherwise, the flow may proceed to step 560 or step 570.

Step 550: adjusting modulation and demodulation of the driving signal according to the speed of the moving part. For example, a new frequency of the driving signals can be set according to the new speed setting of the moving part in order to eliminate or alleviate the electromagnetic interference generated from the moving part. Next, the flow may proceed to step 560 or step 570.

Step 560: determining whether to adjust sensitivity setting. For example, a new setting of sensitivity may be received from a control element 450. The control element 450 may be a knob, a slider, or a wireless controller. When a new setting of sensitivity is received, the flow may proceed to step 562. Otherwise, it may proceed to step 570.

Step 562: changing a threshold for detecting the driving signals according to the adjusted sensitivity setting.

Step 570: prompting the user that there is no external conductive object. For example, the output device 460 may be directly notified to send audio signal, light or visual signal, and vibration signal to prompt the user. In addition, in one embodiment, warning messages may be sent to a remote user via a network communication device.

Step 580: when no external conductive object is detected, notifying the controller of the moving part to start the moving part. Next, the flow may return to step 520.

According to an embodiment of the present application, a capacitance sensing method for emergency stop moving part applicable to a processor of capacitance sensing of approaching or touching object is provided. The capacitance sensing method for emergency stop moving part comprises providing driving signals to a driving electrode and sensing the driving signals induced by a sensing electrode in order to detect an external conductive object approaching or touching a protection shield for the moving part, wherein a first capacitor is formed by the protection shield and the driving electrode, a second capacitor is formed by the protection shield and the sensing electrode; determining a strength of the sensed driving signals; and when the strength of the sensed driving signals exceeds a threshold, notifying a controller of the moving part to stop the moving part.

Preferably, in order to let the user conveniently sets the sensitivity, the method further comprises receiving setting information from a control element; and adjusting the threshold's value according to the setting information.

Preferably, in order to prevent the sensing of the driving signals from electromagnetic interference generated by the moving part at high speed, the method further comprises receiving speed setting information from the controller; and adjusting modulation and demodulation of the driving signals based on the speed setting information.

Preferably, in order to prevent the sensing of the driving signals from electromagnetic interference generated by the moving part at high speed, wherein the modulation and the demodulation of the driving signals are based on frequency.

Preferably, in order to prevent the sensing of the driving signals from electromagnetic interference generated by the moving part at high speed, wherein modulation and demodulation of the driving signals are based on pseudo-random numbers.

Preferably, in order to prompt the user who is in danger, the method further comprises: when strength of the sensed driving signals exceeds the threshold, notifying at least one output device to send a first signal to the user.

Preferably, in order to prompt the user who is in safe, the method further comprises: when the strength of the sensed driving signals is less than the threshold, notifying the at least one output device to send a second signal to the user.

Preferably, in order to save power, the method further comprises: after receiving an instruction indicating that the moving part has started moving, performing the above mentioned steps.

Preferably, in order to provide automatic restart function, the method further comprises: after the controller is notified to stop the moving part, performing repetitively the above mentioned steps until the strength of the sensed driving signal is less than the threshold, notifying the controller to start moving the moving part.

Preferably, in order to conveniently unload the protection shield for cleaning by the user, wherein the driving electrode and the sensing electrode are installed inside or on a surface of a protection shield of a motor of the moving part so as the driving electrode and the sensing electrode do not directly contact conductive material of the protection shield for the moving part.

Preferably, in order to prevent electromagnetic interference caused by the rotations of the motor, wherein there is a shielding layer between a motor of the moving part and the driving and the sensing electrodes, the shielding layer is coupled to ground voltage or a direct current voltage.

According to an embodiment of the present application, a processor of capacitance sensing of approaching or touching object for emergency stop moving part is provided. The processor, comprising: a driving circuit module for providing driving signals to a driving electrode; a sensing circuit module for sensing the driving signals induced by a sensing electrode in order to detect an external conductive object approaching or touching a protection shield for the moving part, wherein a first capacitor is formed by the protection shield and the driving electrode, a second capacitor is formed by the protection shield and the sensing electrode; an interface module for connecting with a controller of the moving part; and a processing circuit for determining a strength of the sensed driving signals; and when the strength of the sensed driving signals exceeds a threshold, notifying a controller of the moving part to stop the moving part via the interface module.

Preferably, in order to let the user conveniently sets the sensitivity, wherein the interface module is further configured for receiving setting information from a control element; and the processing circuit is further configured for adjusting the threshold's value according to the setting information.

Preferably, in order to prevent the sensing of the driving signals from electromagnetic interference generated by the moving part at high speed, wherein the interface module is further configured for receiving speed setting information from the controller; and wherein the processing circuit is further configured for adjusting modulation and demodulation of the driving signals based on the speed setting information.

Preferably, in order to prevent the sensing of the driving signals from electromagnetic interference generated by the moving part at high speed, wherein the modulation and the demodulation of the driving signals are based on frequency.

Preferably, in order to prevent the sensing of the driving signals from electromagnetic interference generated by the moving part at high speed, wherein modulation and demodulation of the driving signals are based on pseudo-random numbers.

Preferably, in order to prompt the user who is in danger, wherein the processing circuit is further configured for when strength of the sensed driving signals exceeds the threshold, notifying, via the interface module, at least one output device to send a first signal to the user.

Preferably, in order to prompt the user who is in safe, wherein the processing circuit is further configured for when the strength of the sensed driving signals is less than the threshold, notifying, via the interface module, the at least one output device to send a second signal to the user.

Preferably, in order to save power, wherein after receiving an instruction indicating that the moving part has started moving, the processor is configured for performing the above-mentioned steps.

Preferably, in order to provide automatic restart function, wherein after the controller is notified to stop the moving part, the processor is configured for performing repetitively the above mentioned steps until the strength of the sensed driving signal is less than the threshold, notifying, via the interface module, the controller to start moving the moving part.

Preferably, in order to conveniently unload the protection shield for cleaning by the user, wherein the driving electrode and the sensing electrode are installed inside or on a surface of a protection shield of a motor of the moving part so as the driving electrode and the sensing electrode do not directly contact conductive material of the protection shield for the moving part.

Preferably, in order to prevent electromagnetic interference caused by the rotations of the motor, wherein there is a shielding layer between a motor of the moving part and the driving and the sensing electrodes, the shielding layer is coupled to ground voltage or a direct current voltage.

According to an embodiment of the present application, a system for emergency stop moving part is provided. The system comprises the abovementioned moving part, the protection shield for the moving part, the driving electrode, the sensing electrode, and the processor of capacitance sensing of approaching and touching object.

Person having ordinary skill in the art can understand that one of the inventive characteristics of the present application is to add conductive material into the protection shield for the moving part such that two capacitors can be formed between the protection shield and the driving electrode and the sensing electrode, respectively. When an external conductive object is detected by the processor 210 of capacitance sensing of approaching or touching object the protection shield via the driving electrode, the protection shield, and the sensing electrode, the controller of the moving part would be notified to stop the operations of the moving part.

Another one of the inventive characteristics of the present application is that the electromagnetic interference signal generated by the high-speed moving parts is put into considerations. And anti-jammer method is facilitated to prevent false stop.

Another one of the inventive characteristics of the present application is that various sensitivities are required in different environments. Therefore, a configurable threshold is provided to adopt to different environments.

Person having ordinary skill in the art can understand that the moving parts as recited in the present application are not limited to the electric fans. Other kinds of dangerous devices such as chainsaws, washing machines, cloth dryers, and dish washers may be applicable to the present application.

While the invention has been described in terms of what is presently considered to be the most practical and preferred embodiments, it is to be understood that the invention needs not to be limited to the above embodiments. On the contrary, it is intended to cover various modifications and similar arrangements included within the spirit and scope of the appended claims which are to be accorded with the broadest interpretation so as to encompass all such modifications and similar structures.

What is claimed is:

1. A capacitance sensing method for emergency stop moving part applicable to a processor of capacitance sensing of approaching or touching object, wherein the capacitance sensing method comprising:
providing driving signals to a driving electrode and sensing the driving signals induced by a sensing electrode in order to detect an external conductive object approaching or touching a protection shield for the moving part, wherein a first capacitor is formed by the protection shield and the driving electrode, a second capacitor is formed by the protection shield and the sensing electrode;
determining a strength of the sensed driving signals; and
when the strength of the sensed driving signals exceeds a threshold, notifying a controller of the moving part to stop the moving part.

2. The capacitance sensing method as recited in claim 1, further comprises:
receiving setting information from a control element; and
adjusting the threshold's value according to the setting information.

3. The capacitance sensing method as recited in claim 1, further comprises:receiving speed setting information from the controller; and adjusting modulation and demodulation of the driving signals based on the speed setting information.

4. The capacitance sensing method as recited in claim 3, wherein the modulation and the demodulation of the driving signals are based on frequency.

5. The capacitance sensing method as recited in claim 1, wherein modulation and demodulation of the driving signals are based on pseudo-random numbers.

6. The capacitance sensing method as recited in claim 1, further comprises:
when a strength of the sensed driving signals exceeds the threshold, notifying at least one output device to send a first signal to the user.

7. The capacitance sensing method as recited in claim 6, further comprises:
when the strength of the sensed driving signals is less than the threshold, notifying the at least one output device to send a second signal to the user.

8. The capacitance sensing method as recited in claim 1, further comprises:
after receiving an instruction indicating that the moving part has started moving, performing all the steps as recited in claim 1.

9. The capacitance sensing method as recited in claim 1, further comprises:
after the controller is notified to stop the moving part, performing repetitively all the steps as recited in claim 1 until the strength of the sensed driving signal is less than the threshold, notifying the controller to start moving the moving part.

10. The capacitance sensing method as recited in claim 1, wherein the driving electrode and the sensing electrode are installed inside or on a surface of a protection shield of a motor of the moving part so as the driving electrode and the sensing electrode do not directly contact conductive material of the protection shield for the moving part.

11. The capacitance sensing method as recited in claim 1, wherein there is a shielding layer between a motor of the moving part and the driving and the sensing electrodes, the shielding layer is coupled to ground voltage or a direct current voltage.

12. A processor of capacitance sensing of approaching or touching object for emergency stop moving part, comprising:
a driving circuit module for providing driving signals to a driving electrode;
a sensing circuit module for sensing the driving signals induced by a sensing electrode in order to detect an external conductive object approaching or touching a protection shield for the moving part, wherein a first capacitor is formed by the protection shield and the driving electrode, a second capacitor is formed by the protection shield and the sensing electrode;
an interface module for connecting with a controller of the moving part; and
a processing circuit for
determining a strength of the sensed driving signals; and
when the strength of the sensed driving signals exceeds a threshold, notifying a controller of the moving part to stop the moving part via the interface module.

13. The processor of capacitance sensing of approaching or touching object as recited in claim 12,
wherein the interface module is further configured for receiving setting information from a control element; and
the processing circuit is further configured for adjusting the threshold's value according to the setting information.

14. The processor of capacitance sensing of approaching or touching object as recited in claim 12,
wherein the interface module is further configured for receiving speed setting information from the controller;and
wherein the processing circuit is further configured for adjusting modulation and demodulation of the driving signals based on the speed setting information.

15. The processor of capacitance sensing of approaching or touching object as recited in claim 14, wherein the modulation and the demodulation of the driving signals are based on frequency.

16. The processor of capacitance sensing of approaching or touching object as recited in claim 12, wherein modulation and demodulation of the driving signals are based on pseudo-random numbers.

17. The processor of capacitance sensing of approaching or touching object as recited in claim 12, wherein the processing circuit is further configured for when strength of the sensed driving signals exceeds the threshold, notifying, via the interface module, at least one output device to send a first signal to the user.

18. The processor of capacitance sensing of approaching or touching object as recited in claim 17, wherein the processing circuit is further configured for when the strength of the sensed driving signals is less than the threshold, notifying, via the interface module, the at least one output device to send a second signal to the user.

19. The processor of capacitance sensing of approaching or touching object as recited in claim 12, wherein after receiving an instruction indicating that the moving part has started moving, the processor is configured for performing all the steps as recited in claim 12.

20. The processor of capacitance sensing of approaching or touching object as recited in claim 12, wherein after the controller is notified to stop the moving part, the processor is configured for performing repetitively all the steps as recited in claim 12 until the strength of the sensed driving signal is less than the threshold, notifying, via the interface module, the controller to start moving the moving part.

21. The processor of capacitance sensing of approaching or touching object as recited in claim 12, wherein the driving electrode and the sensing electrode are installed inside or on a surface of a protection shield of a motor of the moving part so as the driving electrode and the sensing electrode do not directly contact conductive material of the protection shield for the moving part.

22. The processor of capacitance sensing of approaching or touching object as recited in claim 12, wherein there is a shielding layer between a motor of the moving part and the driving and the sensing electrodes, the shielding layer is coupled to ground voltage or a direct current voltage.

23. A system for emergency stop moving part, comprising: the part, the protection shield for the moving part, the driving electrode, the sensing electrode, and the processor of capacitance sensing of approaching and touching object as recited in claim 12.
